(19) United States
(12) Patent Application Publication
(10) Pub. No.: US 2023/0067618 A1
(43) Pub. Date: Mar. 2, 2023

(54) METHOD FOR PRODUCING A DECORATIVE PART AND DECORATIVE PART PRODUCIBLE BY THIS METHOD

(71) Applicant: JOYSONQUIN Automotive Systems GmbH, Rutesheim (DE)

(72) Inventors: Klaus BIENIEK, Muhlacker (DE); Muamet- SADIKU, Stuttgart (DE)

(21) Appl. No.: 17/892,640

(22) Filed: Aug. 22, 2022

(30) Foreign Application Priority Data
Aug. 24, 2021 (DE) 102021121898.5

(51) Int. Cl. B29C 45/00; B29C 45/14

(52) U.S. Cl. CPC B29C 45/0053; B29C 45/14786; B29C 2045/0079; B29K 2033/12

(57) ABSTRACT

A method for producing a decorative part which has a visible side with a decorative layer and an installation side with a substrate layer, wherein a polysiloxane-containing composition is applied to the visible side of the decorative layer to form a cover layer and is then cured. A decorative part which can be produced by this method.

### FIELD OF THE INVENTION

The invention relates to a method for producing a decorative part, in particular a decorative part for a vehicle interior, which has a visible side with a decorative layer and an installation side with a substrate layer, and to a decorative part producible by this method.

### BACKGROUND OF THE INVENTION

Decorative parts, particularly those used in vehicle interiors, have to fulfill high demands in terms of visual and tactile quality as well as dimensional stability and resistance to environmental influences. For this purpose, a construction method is widely used in which a decorative layer, which determines the visual appearance, is provided with a protective transparent cover layer on the visible side of the decorative part. On the opposite installation side, a substrate or substrate layer is arranged which gives the decorative part the necessary dimensional stability and is provided for fastening the decorative part.

A transparent cover layer with high surface quality can be produced, for example, from polyester or polyurethane thick-film coating. However, the coating requires numerous manual finishing operations, which is labor- and cost-intensive. In addition, the clearcoat tends to yellow under the influence of light and temperature, which deteriorates the visual appearance of the decorative part over time. Shrinkage processes can cause the non-smooth surface of a textured decorative layer to gradually form an undesirable image on the surface of the transparent cover layer.

In order to avoid the above-mentioned disadvantages, decorative components and corresponding production processes have become known in which the transparent cover layer is injected in the form of a transparent plastic onto the decorative layer in an injection mold. The amount of finishing work required is reduced in this case. The quality of the visible surface is maintained over a longer period if suitable materials are selected, since the injection-molded plastic material is less sensitive to external influences.

A further development of this method is disclosed in EP 2 298 528 A1. There, the decorative layer is laminated with a transparent film on its side facing the visible side and with a barrier layer on its side facing the installation side. The laminated decorative layer is formed into a preform which is then overmolded with a transparent plastic to form the cover layer and back injection molded with a loadbearing plastic to form the substrate. The result is a decorative part in which a transparent film is arranged between the cover layer and the decorative layer and in which a barrier layer is arranged between the substrate and the decorative layer. The transparent film is formed, for example, from a thermoplastic material, in particular polycarbonate (PC), polymethyl methacrylate (PMMA), polyvinyl butyral (PVB), thermoplastic polyurethane (TPU), or from a composite of these materials. The cover layer is formed from an injection-moldable plastic, in particular polymethyl methacrylate (PMMA).

Another example of a decorative part is disclosed in EP 2 842 742 A1. The decorative part disclosed there comprises a cover layer applied directly to a substrate, wherein the cover layer consists of polyurethane or polyurea and the substrate consists of a mixture of at least one thermoplastic and at least one urethane-based thermoplastic elastomer.

Another example of a decorative part is disclosed in DE 199 14 092 A1. The decorative part disclosed there has a decorative layer and an injection-molded substrate layer connected thereto.

The problem underlying the present invention is to provide a new decorative part for a vehicle interior and a method for producing this decorative part. The decorative part is intended to have a high mechanical resistance, in particular a high scratch resistance and abrasion resistance. In addition, the decorative part should be permanently resistant to external influences, such as mechanical impact or UV radiation, and should also allow the use of inherently sensitive decorative layers.

### SUMMARY OF THE INVENTION

This problem is solved by a method for producing a decorative part which has a visible side with a decorative layer and an installation side with a substrate layer, a polysiloxane-containing composition being applied to the visible side of the decorative layer to form a cover layer and then cured. Furthermore, the problem is solved by a decorative part obtainable in particular by this method, which has a visible side with a decorative layer and an installation side with a substrate layer, wherein the decorative layer is coated on the visible side with a cured polysiloxane-containing cover layer.

Through the use of a polysiloxane-containing cover layer, excellent scratch and abrasion resistance is achieved. At the same time, the cover layer also effectively protects sensitive decorative layers against external influences without impairing the appearance of the decorative layer. In particular, the cover layer has dirt-repellent properties and is easy to clean. At the same time, the cover layer is resistant to common cleaning agents.

### DETAILED DESCRIPTION OF THE PREFERRED EMBODIMENTS

The decorative part described here comprises a substrate layer and a decorative layer applied to the substrate layer. This structure defines the visible side and the installation side of the decorative part. The visible side is the side on which the decorative surface of the decorative layer is visible. The installation side is the side opposite the visible side on which the usually flat substrate layer is applied.

The decorative layer can be formed by wood veneer, metal, paper, plastic or a fabric, for example. Preferably, the wood veneer is a real wood veneer, preferably a precious wood veneer. The wood veneer can be joined on the installation side with an additional blind veneer, wherein the decorative wood veneer and the blind veneer are joined, for example, by means of a fleece impregnated with phenol-melamine resin or a layer of glue. Insofar as the decorative layer is formed from a metal, aluminum, steel and copper are particularly suitable for this purpose. The metal is preferably thin sheet metal. The fabric used can be a textile fabric made of natural or synthetic fibers, glass, carbon, Kevlar fabric, metal or metallized fabric, or a mixed fabric made of several of the aforementioned fabrics, which can be narrow- or wide-meshed and thus make the layer behind it visible, for example the substrate layer behind the decorative layer.

The thickness of the decorative layer is preferably in the range of 0.1 mm to 2 mm inclusively, particularly preferably 0.3 mm to 0.7 mm.

The decorative layer preferably has a hydrophilic surface in order to improve adhesion between the decorative layer and the further layers directly bonded to the decorative layer. In addition, the decorative layer preferably has an open-pored surface in order to achieve a larger contact area between the decorative layer and the other layers directly bonded to the decorative layer.

The cover layer according to the invention is produced by applying and curing a polysiloxane-containing composition to the visible side of the decorative layer. The cover layer can be applied directly to the decorative layer, or one or more intermediate layers can be provided between the cover layer and the visible side of the decorative layer.

Preferably, no further layers are applied to the cover layer. Thus, viewed from the visible side, the cover layer preferably forms the top layer of the decorative part.

In a preferred embodiment, one or more intermediate layers are provided between the cover layer and the decorative layer. Preferably, at least one intermediate layer made of a thermoplastic or thermoset material is used. For example, a polymethyl methacrylate-containing composition is used as the thermoplastic material, and a polyurethane-containing composition is used as the thermoset material. The use of a polymethyl methacrylate-containing intermediate layer is particularly preferred. The intermediate layers are at least partially translucent to ensure the visibility of the decorative layer. The intermediate layers can be colorless or colored.

Providing an intermediate layer, in particular a polymethyl methacrylate- or polyurethane-containing intermediate layer, improves the gloss properties of the cover layer and allows the production of a high-gloss surface. In addition, the intermediate layer, in particular a polymethyl methacrylate- or polyurethane-containing intermediate layer, improves the adhesion as well as the mechanical stability of the cover layer.

The intermediate layers are applied to the visible side of the decorative layer before the cover layer is applied. In a subsequent step, the cover layer is applied to the top intermediate layer.

In a preferred embodiment, an intermediate layer, in particular an intermediate layer containing polymethyl methacrylate or polyurethane, is applied to the decorative layer by injection molding.

In an alternative embodiment, the cover layer is applied directly to the visible side of the decorative layer. In this case, the decorative layer preferably has an open-pored surface. Particularly preferably, the cover layer is applied directly to the decorative layer if the decorative layer has a surface made of metal or a plastic film.

In particular, polyorganosiloxanes are used as polysiloxanes, i.e. polymers in which silicon atoms are linked to one another via oxygen atoms and the silicon atoms are additionally substituted with one or more hydrocarbon radicals. The preferred polysiloxane can, for example, be substituted with alkyl groups, alkenyl groups, aryl groups and/or alkoxy groups. The alkyl groups are preferably linear or branched alkyl groups with 1 to 12 carbon atoms, preferably 1 to 8 carbon atoms, further preferably 1 to 6 carbon atoms, particularly preferably methyl, ethyl, n-propyl or iso-propyl groups. The alkenyl groups are preferably linear or branched alkenyl groups having 2 to 12 carbon atoms, more preferably 2 to 8 carbon atoms. Preferably, they are vinyl groups. The aryl groups preferably comprise 6 to 19 carbon atoms, preferably 6 to 13 carbon atoms. Preferably, they are benzyl or phenyl groups. The alkoxy groups are preferably linear or branched alkoxy groups having 1 to 12 carbon atoms, preferably 1 to 8 carbon atoms, more preferably 1 to 6 carbon atoms. Particularly preferred are methoxy, ethoxy, n-propoxy or iso-propoxy groups. The alkyl groups, alkenyl groups, aryl groups and alkoxy groups may be substituted with one or more halogen atoms, in particular with fluorine atoms.

Particularly preferred substituents are alkyl and alkoxy groups, especially methyl, ethyl, n-propyl, isopropyl, methoxy, ethoxy, n-propoxy and iso-propoxy groups.

The polysiloxane may be substituted with one type of hydrocarbon radical or a mixture of different hydrocarbon radicals. Mixtures of differently substituted polysiloxanes can also be used.

Linear, cyclic, branched and/or crosslinked polysiloxanes can be used. Crosslinked polysiloxanes are particularly preferred. Mixtures of said polysiloxanes may also be used. Preferably, the polysiloxane composition comprises at least one crosslinked polysiloxane.

In a preferred embodiment, crosslinked alkyl-substituted polysiloxanes, in particular crosslinked methyl-substituted polysiloxanes, are used.

In a further preferred embodiment, crosslinked alkyl- and/or alkoxy-substituted polysiloxanes are used, in particular crosslinked polysiloxanes substituted with methyl, ethyl, n-propyl, iso-propyl, methoxy, ethoxy, n-propoxy and/or iso-propoxy groups. Cross-linked, alkyl- and alkoxy-substituted polysiloxanes are also referred to as silicic acid ester-modified polysiloxane resins in the context of the present invention.

The polysiloxanes are preferably used as colloids, particularly preferably in the form of nanoparticles.

The polysiloxane preferably has a weight average molecular weight of 300 to 100,000 g/mol, preferably 500 to 30,000 g/mol, most preferably 750 to 10,000 g/mol. The weight average molecular weight can be determined, in particular, by gel permeation chromatography using polystyrene standards.

In addition to the polysiloxane, the polysiloxane-containing composition usually comprises one or more solvents, in particular organic solvents, in particular alkanols, such as methanol, butanol or 2-propanol. The proportion of polysiloxane in the composition is in total preferably 5% by weight to 100% by weight, preferably 5% by weight to 80% by weight, particularly preferably 10% by weight to 70% by weight, most preferably 40% by weight to 60% by weight, based on the total mass of the composition. The proportion of solvent in the composition is preferably up to 90% by weight, preferably from 20% to 95% by weight, particularly preferably from 30% to 90% by weight, most preferably from 40% to 60% by weight, based on the total mass of the composition.

The proportion of polysiloxane is selected so that the preferably liquid composition has a viscosity suitable for application to the decorative layer. If necessary, the viscosity can be adjusted by diluting a concentrated polysiloxane composition with a suitable solvent, in particular one of the organic solvents mentioned above. The proportion of polysiloxane varies in particular depending on the type of application. If the cover layer is applied by spray application, the total polysiloxane content is, for example, 20% by weight to 80% by weight, particularly preferably 40% by weight to 60% by weight. In the case of a jet application, the total polysiloxane content is, for example, 60% by weight to 100% by weight, particularly preferably 70% by weight to 90% by weight.

Before applying the polysiloxane-containing composition and any intermediate layers, the decorative layer is preferably cleaned. This is done, for example, by a gas stream, such as compressed air. In a preferred embodiment, cleaning is carried out by dry ice blasting, i.e. by irradiating the surface with a mixture of dry ice particles (CO₂ particles) and compressed air. In addition to compressed air, another inert carrier gas can also be used for this purpose. This cleaning removes microparticles from the surface of the decorative layer and enables uniform application of the cover layer and any intermediate layers. If an intermediate layer, in particular an intermediate layer made of a thermoplastic or thermosetting material, is provided between the top layer and the decorative layer, cleaning of the decorative layer can also be dispensed with.

The polysiloxane-containing composition is preferably applied in liquid form. This can be done, for example, by dipping, spraying, flooding or casting. In dipping, the decorative part is passed through a bath of the polysiloxane-containing composition. In the case of flooding and casting, the surface of the decorative part is flooded with the polysiloxane-containing composition, which can be applied by means of one or more nozzles, in particular flooding or rinsing nozzles. The application can be carried out, for example, in a continuous flow or lowering process.

In a particularly preferred embodiment, the polysiloxane-containing composition is applied by spraying. In this way, an extremely uniform coating is achieved with low material consumption. Particularly preferably, the spraying process is carried out by jet spray application without paint mist.

In order to prevent premature reaction of the polysiloxane, the application is preferably carried out under inert gas, for example in a nitrogen atmosphere. This applies in particular to application by spraying.

Particularly good results are obtained if the application is carried out at a temperature of 10° C. to 40° C. and a relative humidity of 30% or more. Particularly preferably, the temperature is 20° C. to 30° C. The relative humidity is preferably 30% to 80%, and more preferably 40% to 70%. Under these conditions, excellent adhesion of the cover layer is achieved.

The applied polysiloxane-containing composition is then cured to form the cover layer.

In one embodiment, curing is carried out at elevated temperature, preferably at a temperature of 50° C. to 100° C. and a relative humidity of 10% to 80%. Particularly preferably, the temperature is 60° C. to 90° C., most preferably 75° C. to 85° C. The relative humidity is preferably 40% to 80%.

In a further embodiment, curing is carried out by infrared irradiation (IR irradiation). Preferably, the cover layer is heated to a temperature of 50° C. to 100° C., more preferably 60° C. to 90° C.

In a further embodiment, curing is carried out by UV irradiation. Preferably, UV light in the wavelength range from 100 nm to 380 nm is used. The radiation used may also contain shorter or longer wavelength components, provided that sufficient intensity is ensured in the specified wavelength range. UV curing can be carried out, for example, by using a gas discharge lamp, in particular a mercury vapor lamp or a metal halogen lamp with gallium-indium doping, iron doping or lead doping. Alternatively, UV curing can be carried out using an LED lamp.

In a particularly preferred embodiment, curing is carried out by UV irradiation in combination with elevated temperature under the above conditions, in particular by UV irradiation in combination with IR irradiation.

A method in which curing is first carried out by IR irradiation and then by UV irradiation is particularly preferred. In particular, the cover layer is cured first by IR irradiation for 1 to 5 minutes and then by UV irradiation for 30 to 60 seconds. Under these conditions, the polysiloxane-containing cover layer obtains excellent dirt-repellent properties while maintaining high transparency and mechanical stability.

The cured cover layer preferably has a layer thickness of 0.25 μm to 25 μm, particularly preferably 6 μm to 10 μm.

The intermediate layers, if applicable, can also be applied to the decorative layer by the methods described above or by other coating methods known from the prior art.

The substrate layer is preferably made of plastic, in particular thermosetting or thermoplastic material. Suitable materials for the substrate layer include urethane (TPU), polycarbonate (PC), acrylonitrile-butadiene-styrene (ABS), polyamide (PA), polypropylene (PP), styrene-acrylonitrile (SAN), styrene-maleic anhydride (SMA), polypropylene ether (PPE), polyphenylene oxide (PPO), or a mixture of several of these plastics. Particularly suitable are, for example, blends of PC and ABS, blends of ABS and PA or blends of PC and SAN. Particularly preferably, the substrate layer comprises a blend of TPU with one or more other plastics, in particular one or more of the above-mentioned plastics.

The plastic of the substrate layer can include further additives. For example, the plastic may be reinforced with glass, carbon or natural fibers. Preferably, the plastic is a glass fiber-reinforced plastic. Furthermore, fillers, such as silica or carbon black, may be included.

To produce the decorative part, the decorative layer is preferably formed into a preform. The shape of this preform essentially corresponds to that of the subsequent decorative part. The preform is produced in a suitable press mold. Before, during or after this forming, the decorative layer can be bonded to the substrate layer. The cover layer can also be applied and cured before or after forming.

The decorative layer and substrate layer are bonded by methods generally known in the art, in particular by pressing or injection molding. For example, the decorative layer can be pressed onto the substrate layer, with SMC (Sheet Molding Compound) or GMT (Glass-Mat-reinforced Thermoplastic) in particular being used as the pressing process. Alternatively, the substrate layer can also be injection molded onto the decorative layer. It is also possible to inject the substrate layer using a reaction injection molding process. The decorative layer and substrate layer can be bonded before or after application and curing of the cover layer.

In the case of an injection molding process, the decorative layer is preferably formed into a preform before being bonded to the substrate layer, the shape of which essentially corresponds to the late decorative part. The substrate layer can then be injected onto the preform, with the preform serving as a die that predetermines the final shape of the decorative part.

In the case of a pressing process, forming the decorative layer and bonding it to the substrate layer can be carried out in a single step. For this purpose, the decorative layer and substrate layer are presented in a flat, planar form and pressed together. Alternatively, the decorative layer can also be formed into a preform before being bonded to the substrate layer. To enable the decorative layer and substrate layer to be pressed together, in this case the substrate layer is also preferably formed into a corresponding preform before bonding.

In order to increase adhesion between the decorative layer and the substrate layer, a bonding agent is preferably applied to the installation side of the decorative layer before it is bonded to the substrate layer. The bonding agent is, for example, glue or a reactive hotmelt adhesive. This is particularly the case with a decorative layer made of metal. If the decorative layer is a wood veneer with blind veneer on the installation side, a fleece impregnated with phenol-melamine resin or glue can also be placed on the installation side of the decorative layer.

In one embodiment, the cover layer and any intermediate layers are applied to an initially flat decorative layer and cured, the resulting composite of cover, intermediate and decorative layers is then formed into a preform, and the preform is finally bonded to the substrate layer.

However, it is preferable not to apply the cover layer and any intermediate layers before forming the decorative layer, but only on the already preformed decorative layer, in order to avoid damage to the cover layer during forming.

If an intermediate layer, in particular a polymethyl methacrylate or polyurethane-containing intermediate layer, is applied to the decorative layer by injection molding, this is preferably done after the decorative layer has been formed. The intermediate layer can thus be applied directly to the preformed decorative layer and does not have to be subsequently formed again. The cover layer is then applied to the intermediate layer without the cover layer having to be formed again.

In a preferred embodiment, therefore, the decorative layer is first formed into a preform, then the preform is bonded to the substrate layer, then one or more intermediate layers are applied to the decorative layer if necessary, and finally the cover layer is applied to the decorative layer and cured.

In another preferred embodiment, the decorative layer is first formed into a preform, then any intermediate layers and the cover layer are applied to the decorative layer and cured, and finally the resulting preformed composite of cover, intermediate and decorative layers is bonded to the substrate layer.

The method according to the invention is illustrated by the following example.

A preform comprising a decorative layer of a wood veneer and a substrate layer of a glass fiber-reinforced polycarbonate/acrylonitrile-butadiene-styrene plastic bonded thereto is provided.

An intermediate layer of polymethyl methacrylate is applied to the visible side of the decorative layer by injection molding in an injection mold.

The preform coated in such a way is removed from the injection mold and transferred to a clean room cell. There, the preform is tempered to a temperature of approx. 23° C. and, at an air temperature of approx. 23° C. and a relative humidity of 60%, a polysiloxane-containing composition is applied by spray application. The composition comprises a polysiloxane in a sprayable dilution of 40% solids content. The spray application is carried out with the following process parameters: Atomizing air 140 NL, horn air 160 NL, application speed of 500 mm/sec and application rate of 130 ml/min.

The polysiloxane-containing composition is then cured at a temperature of 60° C. to 80° C. and a relative humidity of 50% for 90 minutes. Curing is achieved by IR irradiation for 1 to 5 minutes followed by UV irradiation for 30 to 60 seconds.

The cover layer thus obtained has very high mechanical resistance, in particular high scratch and abrasion resistance, and excellent transparency.

What is claimed is:

1. Method for producing a decorative part which has a visible side with a decorative layer and an installation side with a substrate layer, wherein a polysiloxane-containing composition is applied to the visible side of the decorative layer to form a cover layer and is then cured.

2. Method according to claim 1, wherein the polysiloxane-containing composition comprises a crosslinked alkyl- and/or alkoxy-substituted polysiloxane.

3. Method according to claim 1, wherein the proportion of polysiloxane in the polysiloxane-containing composition is in total 5% by weight to 80% by weight.

4. Method according to claim 1, wherein the polysiloxane-containing composition is applied at a temperature of 10° C. to 40° C. and a relative humidity of more than 30%.

5. Method according to claim 1, wherein the polysiloxane-containing composition is cured at a temperature of 50° C. to 100° C. and a relative humidity of 10% to 80%.

6. Method according to claim 1, wherein the polysiloxane-containing composition is cured by IR irradiation followed by UV irradiation.

7. Method according to claim 1, wherein the cured cover layer has a layer thickness of 0.25 μm to 25 μm.

8. Method according to claim 1, wherein the decorative layer is formed by wood veneer, metal, paper, plastic or a fabric.

9. Method according to claim 1, wherein the decorative layer is formed into a preform before the cover layer is applied and cured.

10. Method according to claim 1, wherein at least one intermediate layer of a thermoplastic or thermoset material is applied to the decorative layer before the cover layer is applied.

11. Method according to claim 10, wherein the intermediate layer is applied by an injection molding process.

12. Method according to claim 10, wherein the intermediate layer is a polymethyl methacrylate- or polyurethane-containing intermediate layer.

13. Decorative part having a visible side with a decorative layer and an installation side with a substrate layer, wherein the decorative layer on the visible side is coated with a cured polysiloxane-containing cover layer.

14. Decorative part according to claim 13, producible by a method, wherein a polysiloxane-containing composition is applied to the visible side of the decorative layer to form a cover layer and is then cured.

15. Decorative part according to claim 13, wherein at least one intermediate layer of a thermoplastic or thermoset material is provided between the decorative layer and the cover layer.

16. Method according to claim 15, wherein the intermediate layer is a polymethyl methacrylate- or polyurethane-containing intermediate layer.
